(19) United States
(12) Patent Application Publication
(10) Pub. No.: US 2006/0115618 A1
(43) Pub. Date: Jun. 1, 2006

(54) Highly reflective and corrosion-resistant reflective layer film and its sputtering target

(75) Inventors: Han-Chang Su, Tainan City (TW); Wei-Chao Su, Tainan City (TW)

Correspondence Address: BACON & THOMAS, PLLC, 625 SLATERS LANE, FOURTH FLOOR, ALEXANDRIA, VA, 22314, US

(73) Assignee: Leesan Precious Metal Co., Ltd., Tainan City (TW)

(21) Appl. No.: 10/999,936

(22) Filed: Dec. 1, 2004

(51) Int. Cl. B32B 3/02; B32B 15/01; B32B 15/20

(52) U.S. Cl. 428/64.4; 428/617; 428/618; 428/671; 420/501

(57) ABSTRACT

A highly reflective and corrosion-resistant reflective layer film and its sputtering target includes a sliver alloy film by adding proper amount of main metal alloy (A) that includes cobalt (Co) or manganese (Mn) or two of them in pure sliver, and an auxiliary metal alloy (B) added if desired. The auxiliary metal alloy (B) can be composed of one or more of gold (Au), palladium (Pd), platinum (Pt) and copper (Cu). These metals constitute a silver alloy, with which a sputtering target is made, and a highly reflective and corrosion-resistant layer film is coated on an optical discs by sputtering process. The silver alloy has the amount of silver 80%-99.99%, that of the main metal alloy (A) 0.01%-5%, and that of the auxiliary metal alloy (B) 0.01%-15%.

### BACKGROUND OF THE INVENTION

1. Field of the Invention

This invention relates to a highly reflective and corrosion-resistant reflective layer film and its sputtering target, particularly to one having a reflective layer or a semi-reflective layer and also upgrading laser beam reflecting percentage and its corrosion resistance.

2. Description of the Prior Art

The reflecting principle of optical discs is to shoot laser beam into a disc, and the laser beam produces reflected light of constructive or destructive interference by the information pits of different geometric shapes. Then the constructive or destructive interference is the source of digital records (0 or 1) of the reflected light. Generally speaking, optical discs are mostly provided with a substrate made of polycarbonate and single or plural layers of optical data storage media plated on the substrate. Optical discs are classified into Prerecorded, CD-R, DVD-R of one burning, CD-RW, DVD-Ram, DVD-RW of read/write function, and Prerecorded CD-R of one reflective layer film, DVD, DC-RW, DVD-Ram, DVD-R, and DVD-RW of multi-layer reflective film.

Though optical discs mentioned above have different functions and characteristics owing to designs, the least requirement for any optical disc is a highly reflective layer film capable to reflect laser beam accurately.

In the development made in the last decade, makers have offered many sorts of meal alloys for upgrading highly reflective layer films, such as those exposed in Taiwan patents of Nos. 575674, 574423, 550562, and U.S. Pat. Nos. 6,007,889, 6,280,811, 6,451,402, 6,544,616. They mainly use aluminum (Al) alloy, and silver (Ag) alloy for sputtering target for forming a reflective layer film on an optical disc after sputtering, with a silver white color on its surface. If gold (Au) alloy or copper (Cu) alloy is used for a sputtering target, the surface of an optical disc may look as golden colored. Thus, in selecting material for the reflective layer film of an optical disc, corrosion resistance is another important factor in addition to the “highly reflective percentage” so that those two factors—“highly reflective percentage” and “good corrosion resistance” are the most important for improving the quality of optical discs.

### SUMAMRY OF THE INVENTION

The purpose of the invention is to offer a highly reflective and corrosion-resistant reflective layer film and its sputtering target, which are improved in the reflection of laser beam and corrosion resistance.

In order to attain the objective, the invention offers a kind of highly reflective and corrosion-resistant reflective layer film and its sputtering target by using a metal alloy for the reflective layer film, and the metal alloy is composed of silver (Ag) and main alloy element (A) that includes cobalt (Co) or manganese (Mn) or both of them. Then auxiliary alloy (B) may be added in it, if desired, and it may be gold (Au), palladium (Pd), Platinum (Pt), or copper (Cu) or two or more of them.

### DETAILED DESCRIPTION OF THE PREFERRED EMBODIMENTS

A first preferred embodiment of the invention is a silver alloy including pure silver (Ag) and cobalt (Co). The percentage of the amount of cobalt (Co) is 5% (weight percentage), and the silver alloy with 5% cobalt is used as a first sort of sputtering target for making a silver alloy film, by striking the surface of the sputtering target with high energy particles with sputtering to splash out the material of the silver alloy sputtering target surface, and then sink and form a silver alloy layer film on a substrate, with the thickness of the film controlled in the scope of 100-120 nm. After testing the silver alloy layer film, the reflective data got is shown in a table 1.

TABLE 1

| | | | | | | | | |
|---|---|---|---|---|---|---|---|---|
| Light beam | 450 | 500 | 550 | 600 | 650 | 700 | 750 | 800 |
| wavelength | | | | | | | | |
| (nm) | | | | | | | | |
| Reflective | 89.5 | 90.2 | 93.4 | 93.6 | 94.5 | 95.0 | 95.2 | 96.3 |
| percentage (%) | | | | | | | | |

As can be seen from the table 1, the silver alloy film of the first embodiment has a light beam wavelength 450 nm-800 nm and the reflective percentage 89.5%-96.3%, very high reflective percentage usable for an optical disc with a single reflective layer film such as Prerecorded and CD-R.

A second embodiment of the invention is another sort of silver alloy composed of silver (Ag) and manganese (Mn). The percentage of the amount of manganese (Mn) is 5% (weight percentage), and this silver alloy is used as a second sort of sputtering target for a silver alloy film, and striking the silver alloy sputtering target surface with high energy particles with sputtering so as to splash out the material of the silver alloy sputtering target surface on a substrate to sink and form a silver alloy film thereon, with the thickness of the film controlled as 100-120 nm. After testing the silver alloy film, the reflective data got is shown in a table 2.

TABLE 2

| | | | | | | | | |
|---|---|---|---|---|---|---|---|---|
| Light beam | 450 | 500 | 550 | 600 | 650 | 700 | 750 | 800 |
| wavelength | | | | | | | | |
| (nm) | | | | | | | | |
| Reflective | 87.8 | 89.4 | 91.1 | 92.5 | 93.8 | 94.0 | 94.7 | 95.3 |
| percentage (%) | | | | | | | | |

AS can be seen from the table 2, the second embodiment of the silver alloy film has the light beam wavelength 450 nm-800 nm and the reflective percentage 87.8%-95.3%. In other words, the second embodiment can be used as a kind of highly reflective percentage useable for an optical disc of a single reflective layer film such as Prerecorded and CD-R.

A third embodiment of the invention is also another kind of silver alloy composed of silver (Ag), cobalt (Co) and manganese (Mn) and the percentage of the amount of cobalt and manganese is 5% (weight percentage), This sliver alloy is used as a third sputtering target for making a silver alloy film, by striking the silver alloy sputtering target surface with high energy particles with sputtering so as to splash out the material of the silver alloy sputtering target surface to sink and form a silver alloy layer on a substrate, with the thickness of the film controlled in the scope of 100-120 nm. After testing the third sort of the silver alloy layer, the reflective data got is shown in a table 3.

TABLE 3

| | | | | | | | | |
|---|---|---|---|---|---|---|---|---|
| Light beam | 450 | 500 | 550 | 600 | 650 | 700 | 750 | 800 |
| wavelength | | | | | | | | |
| (nm) | | | | | | | | |
| Reflective | 85.6 | 88.3 | 89.4 | 89.0 | 91.3 | 92.0 | 91.0 | 89.8 |
| percentage (%) | | | | | | | | |

As can be seen from the table 3, the silver alloy film of the third embodiment has the light beam wavelength 450 nm-800 nm and the reflective percentage 85.6%-92.0. In other words, the third embodiment can be used for an optical disc of a single reflective layer film, such as Prerecorded, and CD-R.

Next, a fourth embodiment of the invention is also another kind of silver alloy composed of silver (Ag), cobalt (Co), manganese (Mn), and palladium (Pd) (an auxiliary alloy material, replaceable by pure gold, platinum, or copper, or multiple of these four materials). The percentage of cobalt (Co) is 2.5% (weight percentage), that of manganese 2.5% (weight percentage), and that of palladium 5% (weight percentage). This silver alloy is used as a fourth sputtering target for making a sliver alloy film, by striking the silver alloy sputtering rat get surface with high energy particles so as to splash out the material of the silver alloy sputtering target surface to sink and form a silver alloy layer on a substrate, with the thickness of the film controlled in the scope of 100-120 nm. After testing the silver alloy film, the reflective data got is shown in a table 4.

TABLE 4

| | | | | | | | | |
|---|---|---|---|---|---|---|---|---|
| Light beam | 450 | 500 | 550 | 600 | 650 | 700 | 750 | 800 |
| wavelength | | | | | | | | |
| (nm) | | | | | | | | |
| Reflective | 88.2 | 90.0 | 92.3 | 92.6 | 94.1 | 94.1 | 94.6 | 95.8 |
| percentage (%) | | | | | | | | |

As can be seen from the table 4, the silver alloy film of the fourth embodiment has the light beam wavelength 450 nm-800 nm and the high reflective percentage 88.2%-95.8%. In other words, the fourth embodiment can be used for making an optical disc with a single reflective layer such as Prerecorded and CD-R.

The four embodiments of the invention described above are all sliver alloy films with high reflective function. Next, a fifth embodiment of the invention is a metal film with semi-reflective function, and the sliver alloy of the fourth embodiment is used as the fifth sputtering target in this embodiment, also made by sputtering to from a silver alloy film having the thickness of 8-12 nm on a substrate. After testing its optical reflective percentage with light beam wavelength of 650 nm, it has been proven to have a reflective percentage 20-30%. In other words, the fifth embodiment has a semi-reflective function, possible to be used for an optical disc of many layers such as DVD-9 with a single side and multi-layers.

A sixth embodiment of the invention is a corrosion resistant silver alloy film, which includes a properly thick layer of ZnS—SiO₂; a properly thick layer of Ag—In—Sb—Te and a properly thick ZnS—Sio₂, and then the silver alloy of the fourth embodiment is used as the sputtering target of the sixth embodiment. On the three layers film said above, a layer of silver alloy film of 150 nm thickness is plated by magnetron sputtering so as to make read/write optical discs such as CD-RW, DVD-Ram, and DVD+RW. After testing the sixth embodiment, it has been found to have the required specifications. Then this optical disc is placed in the environment with 85% wetness for ten days, and then tested to have the same result as that not placed in that environment. So the sixth embodiment can be used for write optical discs, possible to wipe and resist corrosion, such as CD-RW, DVD-Ram, DVD-RW, and DVD+RW.

For understanding further the manufacturing processes of various optical discs able to match with the embodiments of the invention, some representative optical discs are described below.

1. Prerecorded optical discs: A digital pattern is formed on a transparent substrate made of polycarbonate, and then a layer of the silver alloy sputtering target in the invention is plated on the digital pattern, and the sliver alloy layer film possesses a highly reflective function, composed of Ag_{w}—Coₓ—Mn_{y}—Pd_{z}, having the percentage of 80%<w<99.99%. 0.01%<x<5%, 0.01%<y<5%, 0.01%<z<15%, usable for making Prerecorded optical discs.

2. Burning once optical discs: A specially designed organic dye is plated on a transparent substrate made of polycarbonate by spin coating, and after drying of the organic dye, the silver alloy sputtering target in the invention is plated on the organic dye by means of splashing to form a layer of silver alloy film composed of Ag_{w}—Coₓ—Mn_{y}—Pd_{z}, having the percentage of 80%<w<99.99%, 0.01<x<5%, 0.01<y<5%, 0.01<z<15%, usable for burning once optical discs such as CD-R.

3. Double-layer optical discs: Single sided double-layer DVD (D-dual layer disc) possesses two recorded optical layers, and the information data of the two layers are written and readable by laser beam including a first “highly reflective layer” and a second “semi-reflective layer”. Of the two layers, the first highly reflective layer is made by the same way as the two ways just described above. The second semi-reflective layer has the reflecting percentage far lower than that of the first layer, mainly because the second layer is plated on the first layer, with the thickness of the second layer being only several tens nanometers, and its reflective percentage being only 18-30%. The second layer has the composure of Ag_{w}—Coₓ—Mn_{y}—Pd_{z}, with its percentage being 80%<w<99.99%, 0.01<x<5%, 0.01%<y<5%, 0.01%<z<15%, able to be used for single-sided double-layer optical discs such as DVD, DVD-R.

4. Read/write optical discs: These discs are developed to have CD-RW, CD-Ram, DVD-R, DVD+RW, and their design principle uses a “phase change” layer possible for reading and writing many times, and its material is mainly Ag—In—Sb—Te or Ge—Te—Sb, and in addition, an electrical layer is used for heat sink. The material used is ZnS—SiO₂. In addition to the films made of the two materials, the phase-change read/write optical discs have to use a highly reflective layer with a high reflective percentage, so in the end it is necessary to add a layer of the silver alloy film of the invention to the film mentioned above. The composure of them is Ag_{w}—Coₓ—Mn_{y}—Pd_{z}, with their percentage being 80%<w<99.99%, 0.01%<x<5%, 0.01<y<5%, 0.01%<z<15%, able to be used for read/write optical discs such as CD-RW, DVD-Ram, DVD-R, and DVD+RW.

While the preferred embodiments of the invention have been described above, it will be recognized and understood that various modifications may be made therein and the appended claims are intended to cover all such modifications that may fall within the spirit and scope of the invention.

What is claimed is:

1. A highly reflective and corrosion-resistant reflective layer film and its sputtering target made of a metal alloy layer, said metal alloy layer composed of silver (Ag) and an main metal alloy (A), said main metal alloy (A) composed of cobalt (Co), or manganese (Mn), or two of them.

2. The highly reflective and corrosion-resistant reflective layer film and its sputtering target as claimed in claim 1, wherein the amount of said main metal alloy (A) is 0.01% to 5% (weight percentage) of the metal alloy layer.

3. A highly reflective and corrosion-resistant reflective layer film and its sputtering target made of a metal alloy, said metal alloy composed of silver (Ag), a main metal alloy (A) and an auxiliary metal alloy (B), said main metal alloy (A) made of cobalt or manganese, or two of them, said auxiliary metal alloy (B) composed of one or more of gold (Au), palladium (Pd), platinum (Pt) and copper (Cu).

4. The highly reflective and corrosion-resistant reflective layer film and its sputtering target as claimed in claim 3, wherein the amount of said main metal alloy (A) is 0.01%-5% (weight percentage) of said metal alloy layer, and that of the auxiliary metal alloy (B) is 0.01%-15% (weight percentage) of said metal alloy layer.
